(19) United States
(12) Patent Application Publication
(10) Pub. No.: US 2024/0426738 A1
(43) Pub. Date: Dec. 26, 2024

(54) OPTICAL PARTICLE COUNTER AND METHODS

(71) Applicant: ENTEGRIS, INC., Billerica, MA (US)

(72) Inventor: Michael Manfred, Minnetonka, MN (US)

(21) Appl. No.: 18/732,498

(22) Filed: Jun. 3, 2024

Related U.S. Application Data
(60) Provisional application No. 63/471,405, filed on Jun. 6, 2023.

(51) Int. Cl. G01N 15/1434; G01N 15/00; G01N 15/14

(52) U.S. Cl. CPC G01N 15/1434; G01N 2015/003; G01N 2015/1486

(57) ABSTRACT

This description relates to optical particle counters, methods of using optical particle counters, and methods of reducing particle count errors during use of an optical particle counter. The method includes a filter placed between the laser source and the flow cell. The filter may be placed at a non-normal angle relative to the laser.

### CROSS-REFERENCE TO RELATED APPLICATIONS

This application claims the benefit under 35 USC 119 of U.S. Provisional Patent Application No. 63/471,405, filed Jun. 6, 2023, the disclosure of which is hereby incorporated herein by reference in its entirety.

### FIELD

This description relates to optical particle counters, methods of using optical particle counters, and methods of reducing particle count errors during use of an optical particle counter.

### BACKGROUND

Optical particle counters have a range of commercial and industrial uses for identifying the presence or amount of certain types of particles within a fluid. The fluid may be a liquid (e.g., an aqueous or organic liquid) or a gas (e.g., clean air of “clean room,” or an exhaust gas).

In certain applications the fluid is a “slurry” (also referred to as a “particle dispersion” or “particle suspension”) that contains small particles dispersed or suspended in a liquid medium. In specific, the slurry may be of a type used with a CMP process (“chemical mechanical planarization” or “chemical mechanical processing”) to process a surface of a semiconductor wafer or microelectronic device (a “CMP substrate”). Specialized optical particle counters are used in these applications to detect relatively large particles (e.g., agglomerated particles) present in the slurry.

The CMP slurry contains small abrasive particles dispersed in an aqueous medium. The slurry is used to planarize a semiconductor wafer surface by applying the slurry to the surface and, using a moving pad (“CMP pad”), contacting the pad and the slurry with pressure against the surface. The slurry and pad are pressed against the surface to abrasively wear away minute amounts of material from the semiconductor wafer surface and to thereby produce an extremely flat, i.e., “planarized,” surface.

The sizes of particles in the slurry can be selected to provide a selected abrasive effect. A slurry can be prepared to have a desired size range of particles, with a size distribution of particles often having a form of a normal (i.e., bell-shaped or Gaussian) curve. Over time, however, after a slurry is prepared and before the slurry is used, individual particles of a slurry tend to coalesce and form larger-sized “agglomerate” particles. These agglomerate particles can be large enough to produce scratches in a semiconductor wafer surface during a planarization step.

An optical particle counter can be used to detect particles in a slurry that are undesirably large, including agglomerate particles formed from multiple individual abrasive particles. In use to detect the agglomerate particles in a slurry, an optical particle counter directs a focused laser light through a slurry sample as the slurry sample moves through a small transparent conduit referred to as a “flow cell.” The laser light passing through the moving slurry can be reflected or interrupted when an agglomerate particle passes through the light. The particle counter includes one or more optical detectors arranged relative to the moving slurry sample to receive light from the laser that passes through or is reflected by the slurry. A change in the intensity of laser light received by a detector can indicate an undesirably large particle in the slurry, such as an agglomerate.

### SUMMARY

An optical particle counter is an extremely sensitive measurement device that relies on a finely-tuned combination of highly-refined optical components such as a laser and transmissive optical devices such as a flow cell, optional filters, as electronic components such as optical detectors and an electronic control system, as well as mechanical components. The combined components are controlled and monitored by computer software that must be programmed and applied to a specific measurement application to correctly interpret electronic signals produced by the optical detectors that receive and measure the intensity of laser light that has passed through or is reflected by a slurry. The system can be highly sensitive to extremely small differences in operating conditions, variability in the performance of components of the system (e.g., laser wavelength and power consistency, which may be affected by laser temperature and current input), and properties of a slurry and slurry components (liquid medium and particles). Changes or variability in one or more of these may cause the optical particle to produce incorrect readings, i.e., “particle count errors.”

When an optical particle counter produces particle count errors, the source of the errors may be obvious, or may be latent and very difficult to identify from among the large number of variabilities, inputs, and operating conditions that combine to produce a measured result. When an optical particle counter produces a reading that is suspected to be erroneous, the potential sources of the error can be numerous. Identifying the specific cause of the error may be a very challenging task that requires a close review of all of the different optical, computer, and electronic components of the apparatus.

As described herein, certain types of particle count errors may be caused by “mode hopping” of a laser. Further, in addition to many other potential causes, mode hopping may be caused by light from a laser used to perform the particle size measurement of a slurry being scattered and re-directed from particles of a slurry back into the laser, i.e., “optical feedback.” When using certain types of optical particle counters are used to measure the presence of undesirably large particles of a slurry such as a CMP slurry, light that is directed into the slurry may strike small particles (micron or nanoscale particles) of the slurry and become scattered and re-directed in a significant amount back into the laser. The scattered and re-directed light that re-enters the laser may induce the effect known as “mode hopping” of the light emitted by the laser. Mode hopping by a laser has the effect of producing variability in the light emitted from the laser, such as unwanted variability in the intensity or frequency of the emitted laser light. When the varying (irregular) laser light is produced by a laser of an optical particle detector, an optical sensor of the optical particle counter that receives that light from the laser can produce erroneous signals, such as a signal that indicates a much higher concentration of detected relatively large particles in a slurry. Potentially, the error may cause the optical particle counter to report a result (particle count) that is more than one-hundred times higher than an expected or known particle count of the slurry.

In one aspect, the invention relates to an optical particle counter. The counter includes: a flow cell adapted to contain a flow of liquid dispersion; a laser that generates a beam of laser light directed at the flow cell; an attenuating filter located between the laser and the flow cell adapted to reduce the intensity of the laser light as the laser light passes from the laser to the flow cell, and that also reduces the intensity of laser light that is re-directed from the flow cell into the laser; and an optical detection system for detecting laser light that exits the flow cell.

In another aspect, the invention relates to a method of detecting particles in a liquid dispersion using an optical particle counter. The method includes: providing a flow of liquid dispersion through a flow cell, the liquid dispersion comprising a liquid medium with particles dispersed in the liquid medium; using a laser, generating a beam of laser light; passing the laser light through the flow of liquid dispersion in the flow cell; before passing the laser light through the flow of liquid dispersion, passing the laser light through a filter that reduces the intensity of the laser light that reaches the flow cell, and also reduces the intensity of laser light re-directed back into the laser that is otherwise capable of producing optical feedback capable of causing mode hopping by the laser; detecting laser light that exits the flow cell.

In yet another aspect, the invention relates to a method of reducing mode hopping of a laser of an optical particle counter that includes a flow cell that contains a liquid dispersion comprising particles dispersed in a liquid, wherein the laser directs laser light into the flow cell and the liquid dispersion, and an optical detector detects electromagnetic radiation that exits the flow cell, the method comprising placing an attenuating filter between the laser and the flow cell to reduce the intensity of laser light passing into the flow cell, and to reduce the intensity of light re-directed back into the laser as optical feedback capable of causing mode hopping.

### BRIEF DESCRIPTION OF THE DRAWINGS

FIG. 1 shows a prior art optical particle counter.

FIG. 2 shows an optical particle counter as described.

FIGS. 3 and 4 show particle count data produced from a prior art optical particle counter of FIG. 1.

FIG. 5 shows data of particle count measurement that includes particle count errors.

FIG. 6 is a diagram of a decision-tree of possible contributors to particle count errors.

### DETAILED DESCRIPTION

The following describes optical particle counters that are useful to detect and measure the presence of certain types of particles in a liquid slurry.

The optical particle counters (or “counters”) can be useful to detect relatively large-sized particles (e.g., relatively large “agglomerates”) in a slurry that contains a concentration of these larger particles along with smaller particles suspended in a liquid medium. The slurry can contain any type of liquid medium and any type of solid particles. The following description will be directed toward one specific example of an application of the inventive optical particle counters and methods to detect certain relatively large-sized particles that can be present in a slurry used for chemical-mechanical planarization of a semiconductor substrate.

Chemical mechanical planarization (CMP) is a process by which chemical and mechanical forces are used together to polish a surface. Chemical mechanical planarization is used for various specific processes by semiconductor device manufacturers to prepare a semiconductor wafer for a manufacturing step. Prior to deposition or fabrication of complex micro- and nano-scale semiconductor components, a working surface of a substrate (e.g., a 300 mm semiconductor wafer that contains microelectronic devices) should meet stringent tolerances for flatness and smoothness to maximize quality and reproducibility. The processing (“planarization”) is performed using a CMP slurry, which is a liquid dispersion that contains a concentration of small (e.g., micron or nanoscale) abrasive particulates suspended (“dispersed”) in a liquid medium.

The abrasive particles can be any type of abrasive particles useful in a chemical mechanical processing composition. Examples include various forms such as zirconia, alumina, ceria, and silica, and other ceramic materials. Any of these may be doped, undoped, and may be prepared by any of various known methods for the different types of particles. The abrasive particles are dispersed or suspended throughout the liquid medium. Various types of abrasive particles (e.g., charged, aggregated, non-charged, non-aggregated) are well known and available commercially. The individual particles may be spherical or nearly spherical in shape, but can have other shapes as well such as generally elliptical, square, or rectangular cross-sections. The individual particles are referred to as primary particles. Commonly, the individual (primary) particles become clustered or bonded together to form a larger particle (“aggregate particle”) from the multiple individual particles.

Aggregate particles that contain a few to several individual particles (e.g., 2, 3, 5, or 10 particles) are common and useful in a slurry. But aggregate particles can grow to a size that becomes large enough for the aggregate particle to cause damage to a substrate during processing. Within a CMP slurry, abrasive particles may coalesce and form larger agglomerate particles due to a pH shift, shear stress, or temperature effects. It is possible for some particles to become excessively large and take on a form of a large “agglomerate” particle or “gel” particle. In a slurry, sizes of individual abrasive particles and acceptable aggregate particles can be on a sub-micron, e.g., nanometer scale. Useful abrasive particles (individual, or acceptable aggregate particles) may have an average particle size in a range from about 0.1, 0.5, 1, 5, 10, or 20 microns to about 100 microns. Larger unwanted aggregate particles have sizes that are greater than the sizes of the useful abrasive particles, e.g., greater than the D90, D95, or D99 of the useful particles, and may be large enough to damage a substrate during processing.

A slurry analyzed by a system as described may contain any suitable amount of abrasive particles, e.g., from an amount of about 0.01, 0.05, 1, 2 or 5 weight percent to about 10, 20, or 30 weight percent abrasive particles based on total weight slurry. The particles have a size distribution that includes a high percent of the total particles having a particle size in a micron range, e.g., at least 90 or 95 percent of particles in the slurry have a particle size of less than 100, 50, 10, 1, 0.5, or 0.1 microns, e.g., at least 90 or 95 percent of the particles have a particle size of less than 5, 1, 0.5, or 0.1 microns, i.e., a measured D90 or D95 of less than 100 microns, or a measured D90, D95, or D99 of less than 5, 1, 0.5 or 0.1 microns.

The slurry contains the abrasive particles dispersed in a liquid medium that typically contains a high concentration of water and an optional small amount of organic additive such as a solvent, which may be a lower alcohol (e.g., methanol, ethanol, etc.), ether (e.g., dioxane, tetrahydrofuran, etc.), among others. An example liquid carrier may comprise, consists essentially of, or consists of water, more preferably deionized water. A carrier that consists essentially of water can contain up to (not more than) 3, 2, 1, 0.5, 0.1, or 0.05 weight percent of another liquid, e.g., a non-water (organic) solvent such as a lower alcohol (e.g., methanol, ethanol, etc.), ether (e.g., dioxane, tetrahydrofuran, etc.), or the like.

To achieve the high quality requirements and high process yield requirements needed for current microelectronic device manufacturing, every variable present in a manufacturing step must be monitored and controlled as closely as possible, including the composition of a CMP slurry used during a planarization step. Potential variabilities of a CMP slurry include the concentration and distribution of abrasive particles within the slurry, particularly the presence and concentration of larger-sized aggregate particles. Large agglomerate particles (e.g. agglomerates particles having a size greater than the D90, D95, or D99 of useful slurry particles, for example greater than 0.5 microns) in a CMP slurry can cause scratch and dig defects on a surface of a wafer during CMP processing. As a result, it is important to monitor the size distribution and concentration of the particulates in the CMP slurry, particularly the presence of aggregate particles that are of an undesirably large size.

Generally, an optical particle counter uses a focused laser beam to detect particles contained in a liquid slurry. The laser beam is directed at a moving sample of the slurry and is transmitted at least partially through the slurry. The light of the laser beam may be transmitted entirely through the slurry, or may be blocked, scattered, or reflected by certain particles in the slurry as the sample passes through the laser beam. Certain small particles such as micron and nano-scale particles that are useful in the slurry may not interrupt or reflect the light of the laser, while larger size particles, e.g., larger-size agglomerates having a particle size that is larger than the useful slurry particles, may either interrupt the light or cause the light to be reflected, deflected, or scattered.

Optical detectors arranged about the sample collect light that passes through the slurry or that is reflected, scattered, or deflected by particles of the slurry. The particle counter uses information from the transmitted light, or from scattered or deflected light to calculate amounts or sizes of particles in the slurry sample.

Example systems include an optical detector on a opposite side of the laser that detects light from the laser after the beam has passed through the slurry. In these example systems, a particle of the slurry that is of sufficient size, that passes through the path of the laser beam, will interrupt light of the laser and temporarily reduce the intensity of the light. The particle is recognized by a temporary reduction in the strength of laser light detected by the optical detector. This type of system is referred to as an “extinction”-type optical particle counting system.

Another type of an example system includes one or more optical detectors arranged relative to a slurry sample that allow the detectors to receive light from the laser that is scattered or deflected by relatively large particles in the slurry sample. In these example systems, a relatively large particle of the slurry that passes through the path of the laser beam will scatter or deflect light of the laser, and is recognized as scattered or deflected light detected by an optical detector arranged to sense this type of scattered or deflected light. This type of system is referred to as a “scattering”-type particle detecting system.

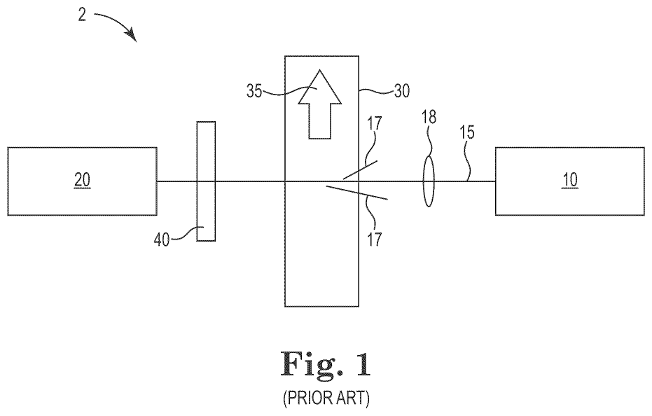

Referring to FIG. 1, illustrated is a prior art optical particle counter 2 for detecting relatively large (e.g., excessively-large, agglomerate) particles in a CMP slurry that contains the unwanted large agglomerate particles in combination with smaller, micron or nano-scale useful slurry particles. Flow cell 30 is made of an optically-transparent material and includes vertical sidewalls that form sides of a channel that is adapted to contain a flow of a sample CMP slurry 35. A flow cell may be made of a transparent material such as quartz or sapphire. An example flow cell may define an internal channel having a rectangular cross-section having width and thickness dimensions useful to allow flow of a CMP slurry through the channel during a process of counting particles using the optical particle counter. An example thickness of an internal flow channel (the direction aligned with the laser as the laser enters the channel) may be in a range from 200 to 400 microns (um). An example width (the direction transverse to the laser as the laser enters the channel) may be in a range from 1.5 to 2.0 millimeters (mm).

Laser 10 produces laser light beam 15 that is directed to pass through lens 18 and flow cell 30. Laser light will pass through the slurry and the useful micron or nano-scale particles of the slurry, but will be interrupted by relatively large, agglomerate particles. Light that is transmitted through flow cell 30 uninterrupted is detected by optical detector 20. In response to light received by optical detector 20, detector 20 produces an electronic digital or analog output signal that correlates to the intensity of the light received light.

During use, relatively large, agglomerated particles in the CMP slurry passing through flow cell 30 partially interrupt laser light beam 15 as the beam passes through flow cell 30 and sample 35. The interruption causes a temporary reduction of intensity of laser light beam 15 received by optical detector 20. By monitoring the intensity of light from the laser light beam that is received by optical detector 20, operational software of optical particle counter 2 may detect, monitor, and report the presence and concentration of relatively large, agglomerate particles that are present in the sample CMP slurry 35 as the sample passes through flow cell 30.

The illustrated optical particle counter 2 includes post-cell optical filter 40 to attenuate the optical power of laser light beam 15. Post-cell optical filter 40 is used to attenuate (i.e., reduce) the power of the laser light beam 15 received by optical detector 20, based on the optical and electronic capabilities of optical detector 20. For example, optical detector 20 may exhibit a sensitivity range and effective discrimination at optical power levels below those produced by laser 10. Accordingly, post-cell optical filter 40 is useful to reduce the optical power of laser light beam 15 that is received by optical detector 20 to a level suited to the capabilities of optical detector 20. As illustrated, filter 40 is an attenuating filter of a type referred to as a “neutral density” filter or “ND” filter, which is a filter that reduces or modifies the intensity of all wavelengths of light similarly.

Laser 10 and detector 20 can each be a laser and a detector that is useful for an optical particle counter as illustrated. An example of a useful laser may be a single mode laser that emits a single frequency of light having a wavelength in a range from 600 to 700 nanometers. Examples are commercially available, with examples being semiconductor laser diode types that emit light at a wavelength of 635 nanometers at a power in a range from 7 to 15 milliwatts. Examples of useful optical detectors 20 are also commercially available, such as Hamamatsu S2506-02 and Hamamatsu S6967.

An optical particle counter such as that shown at FIG. 1 can be highly sensitive to extremely small differences in operating conditions, variability in the performance of components of the system (e.g., laser wavelength and power consistency, which may be affected by laser temperature and current input), and properties of a slurry and slurry components (liquid medium and particles). Changes or variability in one or more of these features of counter 2, and other conditions and features of its operation, may cause counter 2 to produce erroneous readings, i.e., “particle count errors.”

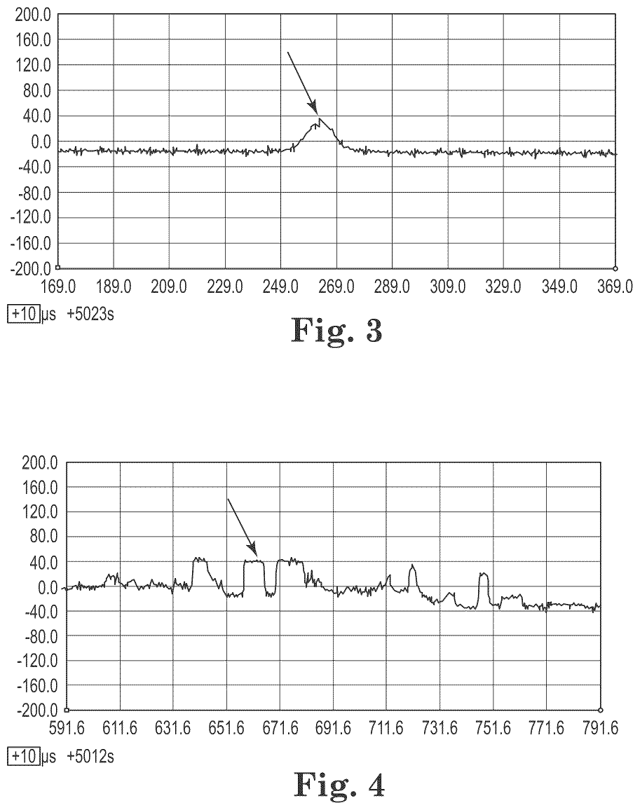

For example, FIGS. 3 and 4 are charts that show examples of data output of an optical particle counter such as counter 2 of FIG. 1. The x-axis is elapsed time and the y-axis is inverse light intensity. FIG. 3 shows a single peak that indicates the presence of a single relatively-large (oversized) agglomerate particle detected in a slurry sample. The gaussian shaped peak is expected from a real particle passing through a laser beam. FIG. 4, however, shows square wave like peaks which would not be produced by a real particle.

When counter 2 is operating in a manner that produces particle count errors, e.g., as shown at FIG. 4, the system is not effective for a purpose of detecting large agglomerate particles. The particle count errors are an over-reporting of relatively large, aggregate particles in a slurry sample. This erroneous over-reporting of excessively large particles in a slurry, which are not in fact present in the slurry, would require the un-warranted rejection of the CMP slurry being monitored.

Generally, a source of a particle count error may either be obvious, or may be latent and very difficult to identify from among the large number of variabilities of the inputs and operating conditions of an optical particle counter that combine to produce a measured result. When an optical particle counter produces a reading that is suspected or known with certainty to be erroneous (for example by being a measure of a known sample), the potential sources of the error can be numerous. Identifying a precise cause of a particle count error may be a very challenging task that requires a close review of all of the many different optical components, computer and software programming, and electronic components of the optical particle counter including operating conditions (temperature) and all operating inputs (e.g., current used for operating a laser).

When attempting to determine a source of a particle count error, the operation of the various optical components of the counter, separately or on combination, can be one of the many potential sources. The operation of the laser is one possible source, including how conditions (temperature) and input (electrical current) may affect light output. A laser is highly sensitive to variabilities of input and operating conditions, including operating temperature (“laser case temperature”), variability of an input current, and “optical feedback,” which is light that passes into the laser from the laser exterior.

Optical feedback can affect the performance of a laser by changing the nature of the light that is emitted from the laser. Under certain conditions, light that is emitted by the laser and that becomes directed back into a laser can cause the laser to experience “mode hopping,” which means that the light output of the laser shifts from one longitudinal mode (wavelength) to a different mode. Mode hopping can produce erratic changes in the wavelength of light being emitted from the laser, along with intensity fluctuations (intensity “noise”). There are different potential causes of mode hopping, including operating conditions of the laser (e.g., a laser's case temperature and current), variability in current used to operate the laser, and optical feedback.

The Applicant has determined that when using an optical particle counter as shown in FIG. 1 to detect large agglomerate particles in a slurry (e.g., a CMP slurry), which contains mostly smaller micron and nano-scale particles, light that is emitted from the laser and directed at the flow cell and slurry can be scattered by the smaller particles in the slurry and may be directed back into the laser in an amount that is sufficient to produce mode hopping, and, that the mode hopping may produce particle count errors such as the multiple, erroneous signal peaks identified at FIG. 4.

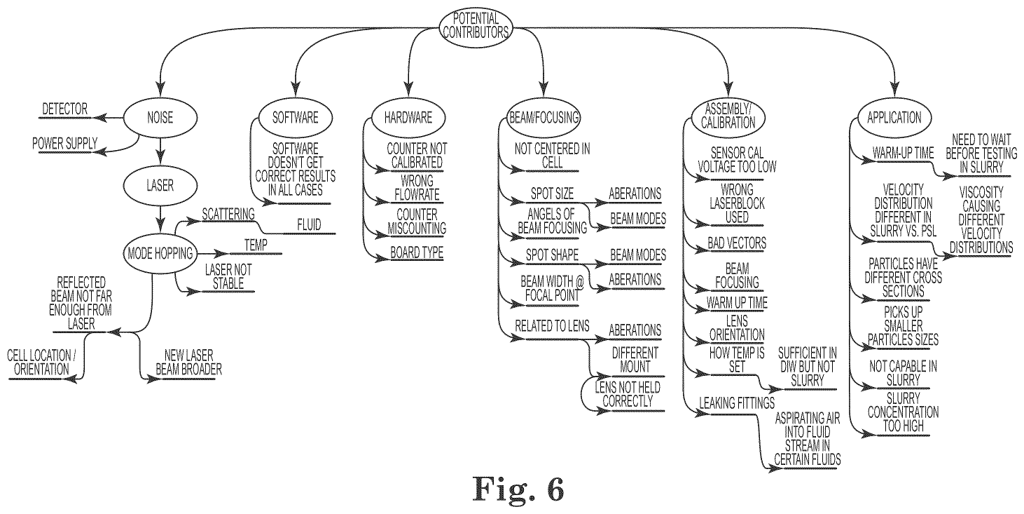

While mode hopping is an understood phenomenon and is known to be caused by laser light being directed back into a laser, a counter 2 as in FIG. 1 would not necessarily or immediately be considered to need protection from optical feedback or mode hopping caused by light being directed from slurry 35 back into laser 10. Mode hopping due to optical feedback would not be an apparent cause for particle count errors in a system of FIG. 1. Other possible causes for particle count errors in the form of excess counts would include: the focused shape of the laser beam; temperature of the laser, which could induce mode hopping; or the beam not being centered in the flow cell. Accordingly, upon identifying an apparent particle count error, the many other operating conditions and inputs of counter 2 would be expected to be more likely sources of an error, as opposed to mode hopping caused by optical feedback due to scattering and re-direction of laser light by micron or nano-scale particles of slurry 35. See FIG. 6 and the related discussion herein.

The Applicant has also determined that particle count errors as shown at FIG. 4, caused by mode hopping, can be prevented by the use of an attenuating filter located between a laser 10 and flow cell 30 of a counter 2 illustrated at FIG. 1.

More generally, as identified by the Applicant and described herein, when using an optical particle counter (e.g., of a type shown at FIG. 1) to detect relatively large, unwanted agglomerate particles in a slurry that contains mostly micron or nanoscale particles, optical feedback can be produced by light that is emitted from a laser being scattered by the slurry and re-directed back into the laser as optical feedback. The optical feedback can produce mode hopping, which can be a source of particle count errors produced by the optical particle counter.

According to optical particle counters described herein, a counter can include an attenuating filter placed between the laser and the flow cell, i.e., a “pre-cell filter.” The “pre-cell” attenuating filter reduces the intensity of laser light that passes through the filter in two directions. First, the filter attenuates light that passes from the laser toward the flow cell, to reduce the intensity of the laser light that passes through the flow cell and is eventually received by the optical sensor. The attenuating filter placed between the laser and the flow cell also attenuates light that is emitted by the laser and is scattered and re-directed by the slurry, and would otherwise become optical feedback by entering the laser. The reduced optical feedback prevents mode hopping.

The filter may be any useful attenuating filter, such as a “neutral density” filter or “ND” filter, which is a filter that reduces or modifies the intensity of all wavelengths of light equally. Other examples are filters sometimes referred to as “laser line filters,” “edge filters,” “rejection filters,” and the like. Example pre-cell filters can be effective to reduce the intensity of light, as the light passes through the filter in one direction, by at least 50, 80, 90, or 95 percent. A pre-cell attenuating filter will reduce the intensity of light that passes in a first direction from the laser toward the flow cell a first time by an amount of at least 50, 80, 90, or 95 percent. The same pre-cell filter will also reduce the intensity of any light that becomes reflected by the slurry and passes a second time through the filter in second direction from the flow cell toward the laser, also by an amount of at least 50, 80, 90, or 95 percent.

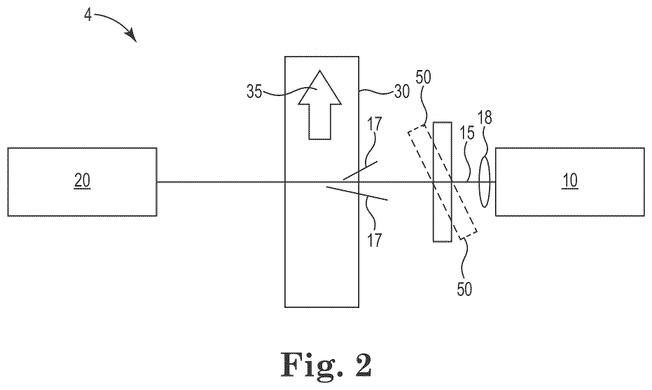

FIG. 2 shows filter 50 in two possible orientations relative to passing laser beam 15. In a first position, in solid lines, filter 50 is perpendicular to laser beam 15. In an alternate position, shown in dashed lines, filter 50 may be angled slightly relative to the direction of beam 15, e.g., at an angle that is from 1 to 30 degrees away from perpendicular to beam 15. The angled filter 50 may cause less reflection from the surface of the filter back into laser 10, further reducing the potential for optical feedback.

Referring to FIG. 2, illustrated is optical particle counter 52 for detecting excessively-large agglomcrate particles in a CMP slurry that contains the agglomerate particles in combination with smaller, useful micron or nano-scale particles. Counter 52 can be adapted to detect agglomerate particles in a CMP slurry that are larger than 80, 90, 95, or 99 percent of useful slurry particles, e.g., to detect agglomerate particles that have a size that is greater than the D80, D90, D95, or D99 of the useful slurry particles. For a slurry that contains at least 90, 95, or 99 percent particles of less than 0.7 microns, the counter may be adapted to detect agglomerate particles that are greater than 0.7 microns, for example. For slurries that contain smaller useful particles, the counter may be adapted to detect particles larger than 0.5 microns, or that are larger than 0.1, 0.15, 0.2, 0.5, 0.7, or 0.8 microns, and up to about 20 microns, while not sensing smaller useful slurry particles, e.g., particles smaller than 0.8, 0.7, 0.5, 0.2, 0.15, or 0.1 microns.

Referring to FIG. 2, particle counter 4 includes an arrangement of components similar to that of counter 2 of FIG. 1, other than the location of an attenuating filter 40, now shown as attenuating filter 50 at a location between laser 10 and flow cell 30. As in counter 2 of FIG. 1, laser 10 produces laser light beam 15 that passes through flow cell 30. The laser light will pass through the slurry and the micron or nano-scale useful slurry particles but will be temporarily interrupted by larger agglomerate particles. Light that is transmitted through flow cell 30 uninterrupted is detected by optical detector 20, and detector 20 senses interruptions in laser beam 15 caused by larger-sized agglomerate particles.

During use, large or agglomerated particles in the CMP slurry passing through flow cell 30 partially interrupt laser light beam 15 as the beam passes through flow cell 30 and sample 35. The interruption causes a temporary reduction of intensity of laser light beam 15 received by optical detector 20. By monitoring the intensity of light from the laser light beam that is received by optical detector 20, operational software of optical particle counter 2 may detect, monitor, and report the presence and concentration of large agglomerate particles that are present in the sample CMP slurry 35 as the sample passes through flow cell 30.

The illustrated optical particle counter 4 includes pre-cell attenuating filter 50 located between laser 10 and flow cell 30 to reduce the intensity of laser light beam 15 before entering the flow cell. Pre-cell filter 50 has the effect of attenuating (i.e., reducing) the power of the laser light beam 15 that passes from laser 10 into cell 30, through slurry 35 and is eventually received by optical detector 20. Pre-cell filter 50 also has the effect of attenuating (i.e., reducing) any the light (17) that is re-directed by slurry 35 back from cell 30 that would otherwise enter laser 10 as feedback.

### Example

Table 1 shows a comparison of results of using particle counters arranged as shown at FIG. 1 and FIG. 2 to detect relatively large size agglomerate particles (>0.8 microns) in a slurry. The slurry contains the unwanted agglomerate particles along with useful smaller (micron or nanoscale) abrasive particles in an aqueous liquid medium from concentrate and mixed with either deionized or filtered, distilled water. The post-cell filter arrangement of FIG. 1 includes an attenuating filter located between the flow cell and the optical detector. The pre-cell filter arrangement of FIG. 2 includes an attenuating filter located between the laser and the flow cell.

TABLE 1
Comparison in Counts using ND Filter at Pre- and Post-Cell Locations
(Counts/ml, of particles larger than 0.8 μm)

| Post-Cell Filter (FIG. 1) | Pre-Cell Filter (FIG. 2) |
|---|---|
| 406,202 | 7,926 |
| 693,320 | 24,263 |
| 98,696 | 12,340 |
| 77,531 | 41,617 |
| 1,110,659 | 42,493 |

The particle counts produced by the counter of FIG. 1 were determined to include particle count errors, based on separate particle count measurements of the slurry.

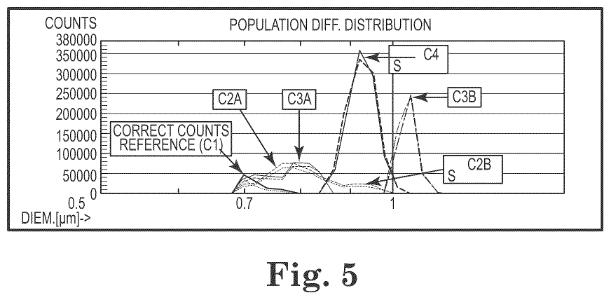

Additionally, multiple alternate particle count measurements of the slurry of table 1 were performed using different sensors as a component of particle counters of the type shown at FIG. 1 (configured to measure particles having a particle size greater than 0.7 microns). See FIG. 5. In FIG. 5, one measured particle size distribution curve C1 (reference), shows an expected distribution of particles sizes. Measurement curves C2, C3, and C4 were produced using three different sensors and show erroneous counts at larger particle sizes. The erroneous measurements C2, C3, and C4 indicate over-counting of large particles, and indicate different sizes of over-counted particles. These show errors that include high counts (C2A) and false peaks (C2B), high counts (C3A) and false peaks (C3B), and high counts (C4).

The source of the particle count errors generated as the erroneous readings was not obvious. The Applicant considered many possible sources of the errors and closely investigated each, individually. For example, FIG. 6 shows a decision-tree that identifies potential contributors to particle count errors in a system of FIG. 1. Based on the large number of different sources of potential particle count errors that may be produced in complex optical particle counters, the possibility that the particle count errors were a result of optical feedback of laser light scattered by the slurry and re-directed back into the laser was not considered a likely source of the particle count errors.

As identified by the Applicant, upon moving the attenuating filter to a position between the laser and the flow cell as shown at FIG. 2, the particle count errors were eliminated.

1. An optical particle counter comprising:
a flow cell adapted to contain a flow of liquid dispersion;
a laser that generates a beam of laser light directed at the flow cell;
an attenuating filter located between the laser and the flow cell adapted to reduce the intensity of the laser light as the laser light passes from the laser to the flow cell, and that also reduces the intensity of laser light that is re-directed from the flow cell into the laser; and
an optical detection system for detecting laser light that exits the flow cell.

2. The counter of claim 1, wherein the filter reduces the intensity of the laser light that passes through the filter by at least 50 percent.

3. The counter of claim 1, wherein the optical detection system comprises an optical detector that receives the laser light that passes through the flow cell, and is adapted to detect a reduction in intensity of the laser light caused by a particle in a liquid dispersion passing through the laser light.

4. The counter of claim 3, wherein the filter is effective to reduce mode-hopping by the laser compared to a comparable counter that does not include the attenuating filter located between the laser and the flow cell.

5. The counter of claim 1, wherein a surface of the filter is oriented at a non-perpendicular angle relative to the beam.

6. The counter of claim 1, wherein the flow cell is a micro flow cell that includes a channel having a 0.4 mm×1.5 mm depth and width.

7. The counter of claim 1, wherein the laser is a semiconductor laser.

8. The counter of claim 1, wherein the laser light includes electromagnetic radiation having a wavelength in a range from 600 to 700 nanometers.

9. The counter claim 1, wherein the laser has a power in a range from 7 to 15 milliwatts.

10. The counter of claim 1, comprising a liquid dispersion in the flow cell, the liquid dispersion comprising a liquid medium and particles dispersed in the liquid medium.

11. The counter of claim 10, wherein the liquid dispersion comprises:
at least 90 weight percent liquid medium, and
less than 10 weight percent dispersed particles,
based on total weight liquid dispersion.

12. The counter of claim 10, wherein the particles are ceramic particles.

13. The counter of claim 10, wherein the particles comprise: silicon oxide (silica), cerium oxide (ceria), zirconia, or alumina.

14. The counter of claim 10, wherein at least 90 percent of the particles have a particle size below 0.1 micron, i.e., (D90) is below 0.1 micron.

15. The counter of claim 10, wherein the counter is adapted to detect particles of a size greater than 0.5 micron by sensing a reduction in intensity of laser light detected by the optical detection system.

16. A method of detecting particles in a chemical mechanical processing slurry using the counter of claim 1.

17. A method of detecting particles in a liquid dispersion using an optical particle counter, the method comprising:
providing a flow of liquid dispersion through a flow cell, the liquid dispersion comprising a liquid medium with particles dispersed in the liquid medium;
using a laser, generating a beam of laser light;
passing the laser light through the flow of liquid dispersion in the flow cell;
before passing the laser light through the flow of liquid dispersion, passing the laser light through a filter that reduces the intensity of the laser light that reaches the flow cell, and also reduces the intensity of laser light re-directed back into the laser that is otherwise capable of producing optical feedback capable of causing mode hopping by the laser; and
detecting laser light that exits the flow cell.

18. The method of claim 17, wherein the filter reduces the intensity of the laser light that passes through the filter by at least 50 percent.

19. The method of claim 17, wherein the optical detection system comprises an optical detector that receives the laser light that passes through the flow cell, and is adapted to detect a reduction in intensity of the laser light caused by a particle contained in a liquid dispersion passing through the laser light.

20. The method of claim 19, wherein the optical detector detects a reduction in intensity of the laser light caused by a particle having a size greater than 0.5 micron.

21. The method of claim 20, wherein the filter is effective to reduce mode-hopping by the laser compared to a comparable counter that does not include the attenuating filter located between the laser and the flow cell.

22. The method of claim 17, wherein the liquid dispersion comprises:
at least 90 weight percent liquid medium, and
less than 10 weight percent dispersed particles,
based on total weight liquid dispersion.
